(19) United States
(12) Patent Application Publication
(10) Pub. No.: US 2010/0322600 A1
(43) Pub. Date: Dec. 23, 2010

(54) CARTRIDGE HEAT EXCHANGER

(76) Inventor: Thomas Edward KILBURN, Pennsburg, PA (US)

Correspondence Address: The BOC Group, Inc., 575 MOUNTAIN AVENUE, MURRAY HILL, NJ, 07974-2082, US

(21) Appl. No.: 12/487,766

(22) Filed: Jun. 19, 2009

(51) Int. Cl. F17C 9/00; F17C 9/04

(52) U.S. Cl. 392/394; 392/401

(57) ABSTRACT

A cartridge heat exchanger for a liquid includes a housing having a bore therein and constructed to be disposed in the liquid; an exterior surface of the housing; and a plurality of fins protruding from the exterior surface. The cartridge is constructed of a material adapted to be disposed in a liquid for which heat exchange is to occur.

The present embodiments relate to heat exchangers.

Certain types of heat exchangers are unacceptable for use in liquids, such as liquid nitrogen (N₂), due to their inefficiency for vaporizing the liquids. Known heat exchangers used with liquid nitrogen are frequently constructed and arranged as separate, remote structures associated with a plant or facility and at which the boil off is permitted to occur. Construction and maintenance of such heat exchangers is both expensive and time consuming, and does not lend itself well to heat exchange within liquid cylinders.

For a more complete understanding of the present embodiments, reference may be had to the following detailed description of the embodiments taken in conjunction with the drawing figures, of which:

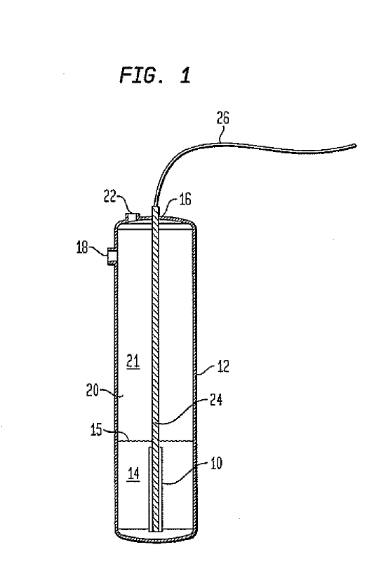

FIG. 1 shows cylinder in which a cartridge heat exchanger embodiment is disposed;

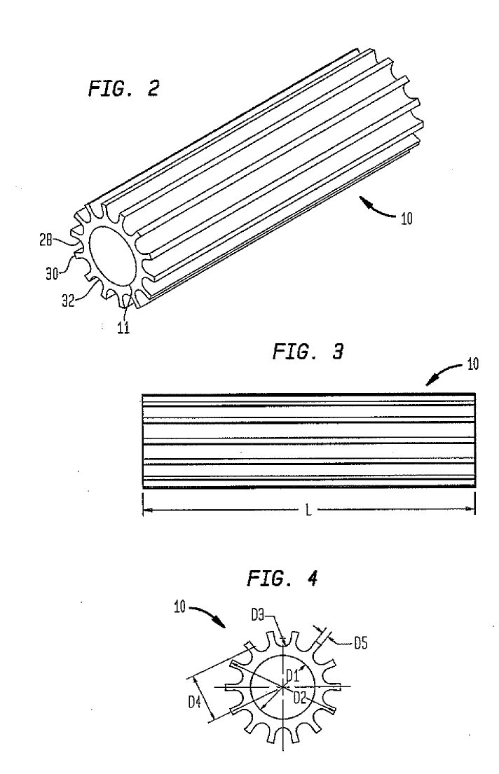

FIG. 2 shows a perspective view of a cartridge embodiment used in FIG. 1;

FIG. 3 shows a side plan view of the cartridge embodiment; and

FIG. 4 shows an end view in cross section of the cartridge embodiment.

Referring to FIG. 1, a cartridge heat exchanger embodiment is shown generally at 10 and is mounted for use within a cylinder 12 or vessel in which a volume of liquid nitrogen (N₂) 14 is contained. The cylinder 12 includes an access port 16 at a top of the cylinder 12, and a load port 18 through which the liquid nitrogen 14 is delivered to an interior chamber 20 of the cylinder 12. A vent port 22 is provided at the top of the cylinder 12.

As shown in FIGS. 1 and 2, the cartridge heat exchanger embodiment (the “cartridge embodiment”) 10 is mounted to an electric heater 24, which in turn has an internal wiring assembly 26. The wiring assembly 26 includes both power and thermocouple wires which extend through the electric heater 24 along substantially an entire length of the electric heater 24. The power wire of the assembly 26 provides the electricity necessary to heat the electric heater 24, while the thermocouple wire controls the heat to the electronic heater 24.

The liquid nitrogen 14 is delivered to the cylinder 12 to a depth sufficient to cover the cartridge embodiment 10 so that it is just beneath a surface 15 of the liquid nitrogen 14. The interior chamber 20 provides head space 21 as shown for the boil off of N₂ gas which may be exhausted through the vent port 22.

Referring also to FIGS. 2-4, the cartridge embodiment 10 is of a tubular or sleeve-like construction having a cylindrical cross section manufactured from copper, although other high heat transfer alloys may be employed. The cartridge embodiment 10 includes at least one open end 11 for receiving an end of the electric heater 24 to which it is mounted, such as by press fitting to the electric heater 24. In this manner of construction, the electric heater 24 with the cartridge embodiment 10 mounted thereto can be lowered into the cylinder 12 and the liquid 14 therein for heating same and providing the necessary boil off vapour to be extracted from the cylinder at the vent port 22.

An exterior surface 28 of the cartridge embodiment 10 is formed with a plurality of fins 30, ridges or splines. The fins 30 may each be formed separately and then attached to the exterior surface 28 of the cartridge embodiment 10 or alternatively, the exterior surface 28 may be constructed and formed with a plurality of the fins 30 such that same is formed as a single integral unit.

As shown in FIGS. 2 and 4, the fins 30 are arranged to run parallel with each other along the exterior surface 28 of the cartridge embodiment 10. Accordingly, troughs 32 also are arranged to run parallel with each other and between respective ones of the fins 30 bordering each trough 32. The fins 30 can alternatively be arranged in different patterns at the exterior surface 28, such as for example at right or obtuse angles.

By way of example only and not to be limiting, a length “L” of the cartridge embodiment 10 can be 6-12 inches (approximately 152-305 millimetres (“mm”)). Further dimensions of the cartridge embodiment 10 include, in the instance where the cartridge embodiment 10 has a length of 6.25 inches (approximately 159 mm); D1 represents an internal diameter of 0.5 inches (approximately 12.7 mm); an external diameter D2 represents a distance from an external most surface of a fin 30 to an external most surface of a fin at an opposed side of the external surface 28 of the cartridge embodiment 10, for example 0.875 inches (approximately 22.2 mm); D3 represents a radius of a trough 32 which occurs between adjacent fins 30 and is 0.63 inches (approximately 16 mm); D4 represents a distance 0.38 inches (approximately 9.6 mm); while a width or thickness D5 of each one of the fins is 0.05 inches (approximately 1.3 mm).

The internal diameter D1 is sized and shaped to receive the electric heater 24 therein. The cartridge embodiment 10 can be slid onto the electric heater 24 and then press-fit or crimped onto the heater so that it retains its position on the heater 24 when the entire assembly—the heater 24 and cartridge embodiment 10—are disposed, such as by being submerged, into the liquid 14.

As shown in the FIGS. 2-4, the fins 30 extend along an entire length of the external surface 28 of the cartridge embodiment 10. However, the extent to which the fins 30 are provided along the exterior surface 28 will be determined by the particular heating application. As shown in the FIGS. 2-4, a trough 32 is disposed between each adjacent pair of fins 30 and it is the coaction of the fins and the troughs, and the relation of the parameters therebetween that provide for an increase in the heat exchange capacity provided by the cartridge embodiment 10. The user can expect a three to four (3-4) fold increase in heat exchange capacity when used with for example liquid nitrogen. Other liquids such as water may also be acted upon by the cartridge embodiment 10.

The cartridge embodiment 10 may be immediately retrofittable to existing electric heaters, such as the electric heater 24 discussed herein. Alternatively, the cartridge embodiment 10 and the electric heater 24, with the wiring assembly 26 can be formed as a single assembly for use as discussed above.

It will be understood that the embodiments described herein are merely exemplary and that a person skilled in the art may make many variations and modifications without departing from the spirit and scope of the invention. All such variations and modifications are intended to be included within the present embodiments as described and claimed herein. It should be understood that the embodiments described above are not only in the alternative, but may be combined.

What is claimed is:

1. A cartridge heat exchanger for a liquid, comprising a housing formed of a material adapted to effect heat exchange of the liquid, the housing having a bore therein, an exterior surface, and a plurality of fins protruding from the exterior surface.

2. The cartridge heat exchanger according to claim 1, wherein the plurality of fins are arranged parallel to a longitudinal axis of the housing.

3. The cartridge heat exchanger according to claim 1, wherein the plurality of fins are integrally formed with the housing.

4. The cartridge heat exchanger according to claim 1, wherein the bore has a circular cross-section.

5. The cartridge heat exchanger according to claim 1, further comprising a heater element disposed in the bore; and a wiring assembly connected to the heater element.

6. The cartridge heat exchanger according to claim 1, wherein the bore is open-ended and the cartridge further comprises a heater element disposed in the open-ended bore and a wiring assembly connected to the heater element.

7. The cartridge heat exchanger according to claim 6, wherein the heater element is removably mounted in the open-ended bore of the housing.

8. The cartridge heat exchanger according to claim 1, wherein the housing and the plurality of fins are formed from copper.

9. The cartridge heat exchanger according to claim 1, wherein a length of the housing is from 152 mm to 305 mm.

10. In a heat exchanger having a heating member, the improvement comprising a cartridge having an internal bore of which at least one end is open ended such that the internal bore can receive the heating member, the cartridge having a plurality of fins arranged at an external surface thereof, and a trough disposed between each adjacent one of the plurality of fins, the cartridge adapted to be disposed in a liquid to effect heat exchange of the liquid.
